(19) United States
(12) Patent Application Publication
(10) Pub. No.: US 2023/0247400 A1
(43) Pub. Date: Aug. 3, 2023

(54) MANAGING REMOTE RESOURCE UTILIZATION BY MOBILE DEVICE

(71) Applicants: Koninklijke KPN N.V., Rotterdam (NL); NEDERLANDSE ORGANISATIE VOOR TOEGEPAST-NATUURWETENSCHAPPELIJK ONDERZOEK TNO, 's-Gravenhage (NL)

(72) Inventors: Sjors BRAAM, Utrecht (NL); Pieter NOOREN, Delft (NL)

(21) Appl. No.: 18/015,884

(22) PCT Filed: Jul. 15, 2021
(86) PCT No.: PCT/EP2021/069690

§ 371 Date: Jan. 12, 2023

(30) Foreign Application Priority Data
Jul. 16, 2020 (EP) 20186291.9

(51) Int. Cl. H04W 4/50; H04W 4/70; H04W 8/00

(52) U.S. Cl. CPC H04W 4/50; H04W 4/70; H04W 8/005

(57) ABSTRACT

A system and method are provided of managing remote resource utilization by a first device, wherein the first device may be configured to use a resource service provided by a remote server, wherein the resource service may enable the first device to utilize a resource of the remote server, wherein the first device may be connected to the remote server via a mobile network infrastructure and configured to use the resource service via remote data communication with the remote server. The system and method may determine whether to setup a second device to provide the resource service to the first device via local data communication as a substitute for the remote server, and if determined, setup the second device to provide the resource service to the first device via local data communication, said setting up comprising transferring state data associated with the resource service to the second device to enable the first device to continue the resource service via local data communication.

### FIELD OF THE INVENTION

The invention relates to a management system and a method of managing remote resource utilization by a device, wherein the device is configured to use a resource service provided by a remote server, wherein the resource service enables the device to utilize a resource of the remote server, and wherein the device is connected to the remote server via a mobile network infrastructure and configured to use the resource service via remote data communication with the remote server. The invention further relates to one or more devices, and to a computer program comprising instructions for causing a processor system to perform the method. The invention further relates to local data communication, such as D2D communication.

### BACKGROUND ART

It is known to enable a device to utilize a resource of a remote server, such as a computing resource and/or a data storage resource, via a mobile network infrastructure. Such devices may also be referred to as User Equipment (UE) or ‘mobile devices’, with the adjective ‘mobile’ referring to devices which are capable of connecting to a mobile network's infrastructure, e.g., to base stations, to obtain wireless connectivity to the mobile network and/or to other networks which are reachable via the mobile network infrastructure. It is noted that the adjective ‘mobile’ does not require that a device is capable of movement, e.g., by being portable or part of a vehicle or aircraft, since also stationary devices may connect to a mobile network.

In general, remote resources may be made available for utilization by the mobile device by providing a resource service to the mobile device. The resource service may for example enable the mobile device to use the resource of the remote server for compute tasks and/or data storage tasks, including but not limited to video transcoding, the analysis of sensor data, rendering of virtual environments and streaming of the resulting rendered pixel data, buffering or medium-term storage of data, etc. Such resource services may, but do not need to be, made available using Application Programming Interfaces (APIs).

For example, in cloud computing, resources of a ‘cloud’ may be made accessible to clients such as mobile devices, with the term ‘cloud’ typically referring to a distributed system of remote servers. The utilization of a cloud computing resource by the mobile device may involve data communication between the mobile device and the remote server(s), which may be carried via the mobile network infrastructure. In cloud computing, the remote server(s) may be located in another network which is, from the perspective of the mobile device, located beyond the mobile network, such as a central cloud or the Internet. In such cases, the mobile network infrastructure may function as an access network to enable the mobile device to access the remote server(s).

It is also known to make remote resources accessible to mobile devices from within the mobile network infrastructure. For example, edge computing is an established concept in mobile networking [1] which uses many elements of cloud computing but brings the computing resources and/or data storage resources towards the so-called edges of the mobile network, and thereby closer to the mobile devices. From such edges of the mobile network, the remote resources may then be accessed at a higher bandwidth, lower latency and/or with higher reliability compared to when utilizing such remote resources from further away, e.g., the aforementioned ‘cloud’.

An example use case for edge computing is connected vehicles (CVs). CVs may be equipped with a large number of sensors which may acquire sensor data. The CVs may upload the sensor data to the edge cloud. In the edge cloud, the data may be analyzed and communicated with other vehicles in the vicinity. Interpreted information may be forwarded in the form of metadata to a central cloud for storage. Depending on the environment (e.g., location, weather) or specific needs of the CV, the CV may send different sensor data and require a different analysis of this data by the edge.

In general, there may be disadvantages to the utilization of a remote resource provided by a remote server. For instance, in the aforementioned example of cloud computing, the bandwidth to the remote server may be low, the latency may be high and/or the reliability may be low. While edge computing addresses at least some of the disadvantages of cloud computing, certain disadvantages may remain. For example, mobile devices may often be physically mobile, for example by being physically carried around by users or by being integrated into physically mobile machines or vehicles. In case mobile devices are highly mobile, for example by being taken onto a fast-moving vehicle, the quality of the connectivity may be negatively affected by mobile handovers and interruptions of coverage caused by tunnels or obstacles. Also, if several mobile devices move jointly, as for example in case of mobile devices on a train or vehicle platoon, this may pose connectivity challenges as many simultaneous handovers under adverse radio conditions remain challenging, despite sophisticated mobile architectures and technology for maintaining mobile connectivity.

Such and other types of connectivity issues may thus interrupt or hinder the remote resource utilization by the mobile device. There may also be other disadvantages beyond connectivity issues. For example, it may be difficult to quickly and repeatedly migrate edge computing resources from one edge node to another edge node so as to have the edge computing resources ‘follow’ the physical path of the mobile device in case the mobile device moves relatively fast, for example by being taken on a train or vehicle platoon. Another disadvantage may be that the edge computing resources of a particular edge node may be insufficient to cope with temporary events, such as sporting matches, concerts, festivals, etc.

He et al. [2] describes a device which can split its task into three parts, with one part remaining for local computing while the other two parts are offloaded respectively to the edge cloud, which is also referred to as edge computing, and to a neighbor device, which is also referred to as device-to-device, D2D, offloading. The D2D offloading is said to address the problem that the limited computation resource at a base station is not always adequate to support all mobile devices in its coverage.

While [2] enables a device to decide between edge computing and DD offloading for a particular task, it cannot be used to improve resource services which are already provided by a remote server to a mobile device. In addition, [2] is limited to offloading only those tasks which can be locally performed, and thus cannot be used to improve the many types of resource services which cannot be performed locally by a device given the complexity of the resource service, computationally or otherwise.

Reference [3] describes providing an application service program via DD-enabled devices, namely by enabling a UE to access an application service program via a DD relay network. In particular, a control method is described for selecting at least one relay gateway in the DD relay network as a mobile-edge cloudlet for the UE. An application service program may be performed by the mobile -edge cloudlet, and the UE may receive a corresponding response with respect to the application service program without accessing to a core network. Reference [3] does not describe providing the application service program using edge nodes of a mobile network.

### REFERENCES

[1] ETSI White Paper No. 28—MEC in 5G networks; First edition—June 2018, ISBN No. 979-10-92620-22-1

[2] Y. He, J. Ren, G. Yu and Y. Cai, “Joint Computation Offloading and Resource Allocation in D2D Enabled MEC Networks,” ICC 2019-2019 IEEE International Conference on Communications (ICC), Shanghai, China, 2019, pp. 1-6.

[3] U.S. Pat. No. 10,270,884 B2

### SUMMARY OF THE INVENTION

It may be desirable to be able to improve upon providing a resource service from a remote server to a device via a mobile network infrastructure.

Briefly speaking, the following aspects of the invention may involve providing a management system which may be configured to initiate an offloading of the resource service from the remote server to another device in situations where the other device is in local data communication range of the (first) device and is capable of providing the resource service to the first device via local data communication. Such local data communication may be independent of the mobile network infrastructure, and may therefore address problems in the remote resource utilization which relate to connectivity issues with the mobile network infrastructure. Such offloading to another device may also provide advantages such as decreasing latency, freeing up the resources of the remote server, etc.

In accordance with a first aspect of the invention, a method may be provided of managing remote resource utilization by a first device, wherein the first device may be configured to use a resource service provided by a remote server, wherein the resource service may enable the first device to utilize a resource of the remote server, wherein the first device may be connected to the remote server via a mobile network infrastructure and configured to use the resource service via remote data communication with the remote server, wherein the first device may be capable of local data communication with other devices independently of the mobile network infrastructure. The method may comprise, by a management system:
identifying a second device which is in local data communication range of the first device and which is capable of providing the resource service to the first device via local data communication;
determining whether to setup the second device to provide the resource service to the first device via local data communication as a substitute for the remote server;
if determined to setup the second device, setting up the second device to provide the resource service to the first device via local data communication, wherein setting up may comprise transferring state data indicative of a state of the resource service from the remote server to the second device to enable the first device to continue the resource service from the second device after ceasing to use the resource service from the remote server.

In accordance with a further aspect of the invention, a computer-readable medium may be provided comprising transitory or non-transitory data representing a computer program. The computer program may comprise instructions for causing a processor system to perform the computer-implemented method.

In accordance with another aspect of the invention, a management system may be provided for managing remote resource utilization by a first device, wherein the first device may be configured to use a resource service provided by a remote server, wherein the resource service may enable the first device to utilize a resource of the remote server, wherein the first device may be connected to the remote server via a mobile network infrastructure and configured to use the resource service via remote data communication with the remote server, wherein the first device may be capable of local data communication with other devices independently of the mobile network infrastructure. The management system may comprise:
a network interface to the mobile network infrastructure;
a processor subsystem which may be configured to:
   identifying a second device which is in local data communication range of the first device and which is capable of providing the resource service to the first device via local data communication;
   determining whether to setup the second device to provide the resource service to the first device via local data communication as a substitute for the remote server;
   if determined to setup the second device, setting up the second device to provide the resource service to the first device via local data communication, wherein setting up may comprise transferring state data indicative of a state of the resource service from the remote server to the second device to enable the first device to continue the resource service from the second device after ceasing to use the resource service from the remote server.

In accordance with another aspect of the invention, a device may be configured to use a resource service provided by a remote server, wherein the resource service may enable the device to utilize a resource of the remote server, wherein the device may comprise:
an infrastructure network interface to a mobile network infrastructure, wherein the remote server may be reachable via the mobile network infrastructure;
a local network interface for local data communication with other devices independently of the mobile network infrastructure;
a processor subsystem which may be configured to:
   using the infrastructure network interface, use the resource service of the remote server via remote data communication with the remote server;
   using the local network interface, identify a further device which is in local data communication range of the device and which is capable of providing the resource service to the device via local data communication;
   using the infrastructure network interface, provide identification data identifying the further device to a management server which is configured to manage remote resource utilization by the device; and
   on receiving a message which indicates that the resource service is available from the further device, switching from using the resource service of the remote server via the mobile network infrastructure to using the resource service from the further device via local data communication.

In accordance with another aspect of the invention, a device may be provided which may be configurable to provide a resource service to a further device, wherein the resource service may enable the further device to utilize a resource of the device, wherein the device may comprise:
an infrastructure network interface to a mobile network infrastructure;
a local network interface for local data communication with other devices independently of the mobile network infrastructure;
a processor subsystem which may be configured to:
   using the infrastructure network interface, receiving state data indicative of a state of the resource service;
   using the local network interface, provide the resource service via local data communication to the further device, wherein the resource service is setup by the processor subsystem to continue at the state indicated by the state data.

The above measures may involve managing the remote resource utilization by a first device using an entity which is separate of the first device, namely using a management system. The management system may for example be part of the mobile network infrastructure, and may be configured to manage the remote resource utilization of the first device. Such management may include deciding in certain situations whether to offload a resource service, which is utilized by the first device, from (1) a remote server, which may only be accessible by the first device via the mobile network infrastructure, to (2) a second device, which may be accessible by the first device via local data communication. Here, ‘local data communication’ may refer to a type of data communication which is independent of the mobile network infrastructure, in that such data communication may not rely on the mobile network infrastructure, e.g., on base stations or the like. Since such data communication typically has a limited physical range, e.g., of tens or hundreds of meters, the communication technique may be referred to as ‘local’.

In general, the local data communication technique may use a same principal type of data communication as is used for the mobile network connectivity, but which may be operated in a different mode so as not to rely on the mobile network infrastructure. An example of such a local data communication technique is device-to-device, D2D, communication in which, instead of using cellular communication with base stations, devices may establish a direct communication channel between themselves using radiofrequency-based data communication in a licensed or unlicensed spectrum, either on a one-to-one basis or by establishing a local network in which other devices may act as so-called D2D relays. However, the local data communication technique may also be a different type of communication technique than used for the mobile network connectivity. For example, the mobile network may be based on a 4G, 5G or next generation mobile network standard, while the local data communication may be based on Wi-Fi (Direct), Zigbee, Bluetooth, Li-Fi, etc.

To determine whether the resource service is to be offloaded to the second device, the management system may determine whether a second device is capable of local data communication with the first device and capable of providing the resource service to the first device via the local data communication. This may for example involve determining whether a second device is within local data communication range of the first device, since such local data communication may have a limited range. There are various ways for determining whether a second device is within local data communication range of the first device, for example based on one of the devices being able to discover another device via the local data communication, or on devices being connected to a same base station, etc. The ability of the second device to provide the resource service may also depend on various other factors, such as the resource requirements of the compute task and/or data storage task associated with the resource service, the second device's current resource allocation, the second device's connectivity to the mobile network infrastructure, etc.

It will be further appreciated that any criteria which relate to the suitability of a second device for providing the resource service to the first device via local data communication may be evaluated in any suitable order, e.g., consecutively or simultaneously. For example, it may be first determined which devices are within local data communication range of the first device, and from this set of devices, it may be determined which devices are capable of providing the resource service via local data communication to the first device.

The management server may further decide whether to setup the second device to provide the resource service to the first device via local data communication as a substitute for the remote server. Namely, it may not always be desirable to offload the resource service from the remote server to the second device, even if a suitable second device is available. For example, a decision to offload the resource service to a second device may be based on various considerations, such as resource considerations which may relate to the remote server, the mobile network infrastructure, the first device and/or to the second device, but may also be based on mobility patterns of the devices and various other types of factors. In general, a decision to offload may represent an exception to a norm of using remote servers to provide resource services to devices.

If decided to setup the second device to provide the resource service to the first device via local data communication, the management server may then setup the second device by transferring state data indicative of a state of the resource service from the remote server to the second device. Such state data may thereby capture a current state of the compute task and/or data storage task before offloading the resource service to the second device. The transfer of the state data may thereby enable the first device to continue the resource service from the second device after ceasing to use the resource service from the remote server. For example, if the compute task is a transcoding of a video, the state data may define a group of pictures which was previously transcoded. Thereby, the second device may continue with transcoding a following group of pictures.

The offloading of the resource service may elsewhere also be referred to as a ‘migration’ of the resource service. In general, the way to migrate resource services from one entity to another is known per se ([4], see ‘further references’ section below). For example, similar techniques may be used to offload the resource service from the remote server to the second device as may be used to migrate edge computing resources from one edge node to another edge node. As in the case of such migration of edge computing resources, the migration of the resource service to the second device may involve transferring other information besides the state data. In a specific example, the management system may cause a container, such as a Docker or Kubernetes container, to be provided the second device, for example by transferring the container to the second device or by informing the second device where the container may be obtained. The management system may further request the second device to instantiate the container so as to instantiate the resource service, and may transfer the container's state from the remote server to the second device. Another example is the initiation of a Virtual Machine (VM) image and transfer of the VM's state. In general, the transfer of state data may enable the resource service to be continued from the second device from a same state as when ceasing to use the resource service from the remote server. This may allow the migration to be seamless, in that the first device may not notice an interruption of the resource service, or such an interruption to be only minor in nature.

The above measures may have the effect that the remote resource utilization of a device may be managed by a management system, in that the management system may decide to offload a resource service from a remote server to a second device which is within local data communication range of the first device. Thereby, the resource service may be made available locally to the first device, i.e., via local data communication. This may make the resource service less prone to connectivity issues related to the mobile network infrastructure. Such connectivity issues may for example arise in case of highly devices, where issues may arise due to repeated handovers between base stations, varying quality of the radio link to the base stations and/or repeated migration of edge computing resources between edge nodes. In many cases, nearby devices may share a same or similar mobility pattern, for example in a train or a vehicle platoon. By offloading the resource service to a nearby device, the entity providing the resource service, i.e., the second device, may move along with the client, i.e., the first device, and may thereby avoid or reduce such types of connectivity issues. However, also with stationary or less devices, the offloading of a resource service to nearby devices may have advantages. For example, during an event, such as a sporting match, concert or festival, the edge nodes which are located nearby the base station(s) may be overloaded, while nearby devices may have sufficient capacity to take over the resource service from the edge node.

Another advantage may be that the decision to offload may be taken by another entity than the first device. In particular if the management system is part of the mobile network infrastructure, the management system may have more information available to base its decision on, compared to the first device alone. This may allow a better-informed decision on whether to offload the resource service.

In an embodiment, the method may further comprise:
evaluating a metric which at least in part characterizes the providing of the resource service by the remote server or by the second device;
wherein the determining whether to setup the second device to provide the resource service may be based on the metric.

The decision on whether to offload the resource service to the second device may be dependent on resource considerations which may relate to the remote server, to the part of the mobile network infrastructure via which the resource service is provided by the remote server, and/or to the second device. More specifically, the resource considerations may pertain to a performance and/or allocation characteristic of the remote server, the network, and/or the second device. Accordingly, a metric may be evaluated which may quantify one or more of these factors. Depending on for example a value of the metric, a decision may be taken whether to setup the second device to provide the resource service to the first device. It will be appreciated that the metric may output a single value but also a set of values. The evaluation of the metric may for example involve thresholding or applying a rule-based system to the metric's output. In some examples, the metric may be a performance metric or an allocation metric or a combination of both.

In an embodiment, the metric may be indicative of at least one of:
a network performance characteristic of at least part of the mobile network infrastructure used for the remote data communication;
a server performance characteristic of the remote server;
a device performance characteristic of the second device;
a network allocation of at least part of the mobile network infrastructure used for the remote data communication;
a server resource allocation of the remote server; and
a device resource allocation of the second device; and
a quality of service which is experienced by the first device when using the resource service via the mobile network infrastructure.

For example, the decision whether to offload or not may be based on a quality of service which is experienced by the first device when using the resource service via the mobile network infrastructure. Such a quality of service may for example be measured by the management system, or reported by the first device. In addition, or alternatively to basing the decision on the quality of service, other characteristics may be taken into account in the decision to offload or not. For example, if the current server performance is insufficient to provide the resource service, it may be decided to offload the resource service to the second device. In yet another example, it may be taken into account what the current resource allocation of the second device is, e.g., in terms of load, memory, storage, etc., or what the expected resource allocation of the second device is after offloading the resource service from the remote server to the second device.

In an embodiment, the determining whether to setup the second device to provide the resource service may be based on an estimated change in the metric when using the second device to provide the resource service as the substitute for the remote server. The decision to offload or not may specifically be based on an estimated change in the performance or allocation in one of the entities. For example, if it is estimated that the resource allocation of the second device may be exceeded by offloading the task of providing the resource service to the second device, it may be decided against such offloading. Conversely, if it is estimated that the resource allocation is not exceeded by such offloading, it may be decided to proceed with the offloading.

In an embodiment, the determining whether to setup the second device to provide the resource service may be further based on a presence of a number of other devices which use the resource service from the remote server and which are reconfigurable to use the resource service from the second device via local data communication. The decision whether to offload or not may be based on whether the resource service may also be utilized by other devices in the vicinity of the second device. This may allow the advantages for the first device of offloading to be also obtained for other devices. In particular, any overhead in setting up the second device to take over the task of providing the resource service may on a per device basis be relatively small if the second device may then provide the resource service also to other devices in its vicinity. With continued reference to the example of devices being highly mobile and sharing a same or similar mobility pattern, the same or similar types of connectivity issues may apply to a set of devices, which may be jointly addressed by the aforementioned offloading of the resource service to the second device.

In an embodiment, the method may further comprise requesting the second device to determine and identify the number of other devices by sending a discovery request using local data communication. To be able to serve also other devices, it may be a prerequisite that the other devices are located in local data communication range of the second device. This may be determined in an efficient and reliable manner by the second device itself, namely by the second device sending a discovery request using the local data communication technique. Namely, any devices which are discovered by such a discovery request may be considered to be in local data communication range of the second device. It is noted that such a discovery request may also identify the resource service which is considered to be offloaded to the second device, e.g., to specifically identify other devices which make use of this resource service.

In an embodiment, the method may further comprise, after setting up the second device to provide the resource service, informing the first device that the second device is available for providing the resource service via local data communication as the substitute for the remote server. For example, the management server may directly inform the first device of the availability of the resource service from the second device, or may request the second device to announce the availability to the first device via local data communication. Upon receiving such an announcement, the first device may switch to using the resource service from the second device.

In an embodiment, the determining whether to setup the second device to provide the resource service may be further based on a mobility pattern of the first device and/or the second device. It is known per se to determine such mobility patterns, for example from information available within the mobile network. For example, a mobility pattern may be determined by tracking the base stations to which respective devices connect over time. Alternatively, geolocation information may be obtained from the devices themselves, for example in the form of GPS information or the like. It may be advantageous to decide to offload the resource service to the second device if the second device shares a same or similar type of mobility pattern with the first device. Here, ‘same or similar mobility pattern’ may include both devices being substantially stationary or moving in substantially a same direction with a similar speed. It may be disadvantageous to decide to offload the resource service to the second device if both devices appear to move away from the other. Such considerations may be evaluated by the management system, e.g., using a rule-based system, to decide whether or not to offload the resource service to the second device.

In an embodiment, the local data communication may comprise device-to-device (D2D) communication, for example using Proximity Services, ProSe ([5], see also the ‘further references’ section below). For example, the identification of other devices within a D2D communication range may be based on a device sending a ProSe discovery request via D2D communication. In a specific example, such a ProSe discovery request may indicate the service being sought or offered.

In an embodiment, the remote server may be an edge node or a system of edge nodes of the mobile network infrastructure, and the resource service may be an edge application service. The management system may thus be configured to offload an edge application service from an edge node to the second device if this is deemed advantageous for the first device and/or for the edge node.

In an embodiment, the mobile network infrastructure may be network infrastructure of a mobile network which adheres to one or more 3GPP standards.

It will be appreciated by those skilled in the art that two or more of the above-mentioned embodiments, implementations, and/or aspects of the invention may be combined in any way deemed useful.

Modifications and variations of any one of the systems, methods and/or computer programs, which correspond to the described modifications and variations of another one of these systems, methods and/or computer programs, and vice versa, may be carried out by a person skilled in the art on the basis of the present description.

### FURTHER REFERENCES

[4] K. Govindaraj and A. Artemenko, “Container Live Migration for Latency Critical Industrial Applications on Edge Computing,” 2018 IEEE 23rd International Conference on Emerging Technologies and Factory Automation (ETFA), Turin, 2018, pp. 83-90, doi: 10.1109/ETFA.2018.8502659

[5] 3rd Generation Partnership Project; Technical Specification Group Services and System Aspects; Proximity-based services (ProSe); Stage 2 (Release 15), 3GPP TS 23.303 V15.1.0 (2018 June)

### BRIEF DESCRIPTION OF THE DRAWINGS

These and other aspects of the invention are apparent from and will be elucidated with reference to the embodiments described hereinafter. In the drawings,

FIGS. 1A-1C showing a group of user equipment moving between base stations, with the user equipment making use of edge computing resources provided by respective edge nodes, and with the mobility of the user equipment causing the providing of the edge computing resources to be migrated between edge nodes;

FIG. 2A shows an information flow between an edge node and three user equipment UE1-UE3 to cause one of the user equipment to provide edge computing application services to the other user equipment as a substitute for the edge node;

FIG. 2B shows a result of FIG. 2A, resulting in UE2 providing edge computing application services to UE1 and UE3 via D2D communication;

FIG. 3 shows the edge node being configured to monitor a quality of service experienced by the user equipment when utilizing edge computing application services from the edge node, and to trigger an offloading of the edge computing application services to UE2 if the quality of service is insufficient;

FIG. 4 shows a central server being configured to manage the offloading of edge computing application services to user equipment;

FIG. 5 shows a bottom-up approach in which UE3 seeks to use application service(s) from UE2, with UE2 having been previously setup to serve UE1;

FIG. 6 shows UE2 as candidate serving UE notifying the edge node EN that UE1 as client UE is seeking to obtain application services via D2D communication;

FIG. 7 shows how to coordinate the offloading while using another UE, namely UE4, as a D2D relay node between UE1 and UE2;

FIG. 8 shows how to coordinate the offloading, where the procedure is repeated to find a better suited UE for offloading the application service(s);

FIG. 9 shows how to coordinate reverting an offloading to UE2;

FIG. 10 shows a device comprising a network infrastructure interface, a D2D communication interface, a processor subsystem and a data storage;

FIG. 11 shows a management system comprising a network infrastructure interface, a processor subsystem and a data storage;

FIG. 12 shows a computer-readable medium comprising data; and

FIG. 13 shows an exemplary data processing system.

It should be noted that items which have the same reference numbers in different figures, have the same structural features and the same functions, or are the same signals. Where the function and/or structure of such an item has been explained, there is no necessity for repeated explanation thereof in the detailed description.

### LIST OF REFERENCE AND ABBREVIATIONS

The following list of references and abbreviations is provided for facilitating the interpretation of the drawings and shall not be construed as limiting the claims.

BS base station

CS central server

D2D device-to-device

EN edge node

QOS quality of service

UE user equipment

UE-G group of user equipment

0-9 messages/steps in information flow

1′, 1″, 2′, 2″ messages/steps in information flow

3′, 3″, 4′, 9′, 9″ messages/steps in information flow

11-15 messages/steps in information flow

21-25 messages/steps in information flow

60 mobile network infrastructure

70 wireless data communication

80 D2D data communication

90 backhaul connection

92 message/step in information flow

100 device (user equipment)

110 network infrastructure interface

120 D2D communication interface

140 processor subsystem

160 data storage

200 management server

210 network infrastructure interface

240 processor subsystem

260 data storage

300 computer-readable medium

310 non-transitory data

1000 exemplary data processing system

1002 processor

1004 memory element

1006 system bus

1008 local memory

1010 bulk storage device

1012 input device

1014 output device

1016 network adapter

1018 application

### DETAILED DESCRIPTION OF EMBODIMENTS

The following embodiments relate to the offloading of a resource service, which may be provided by a remote server to a first device and which may be offloaded from the remote server to a second device, with such offloading being initiated by a management system in certain situations where the second device is in local data communication range of the first device and is capable of providing the resource service to the first device via local data communication.

The resource service may in general enable a device acting as a client to access a resource of the remote server acting as a host, such as a computing and/or storage resource. The resource service may in some embodiments provide the client with direct access to the resource, thereby providing the client with flexibility on how to utilize the resource. For example, the remote server may provide the device with remote access to a compute environment in which the device may execute software. In other embodiments, the remote server may offer a specific service to the client, e.g., a transcoding service, a video analysis service, etc., which may be accessed and utilized by the device via an API or a similar mechanism.

By way of example, the following assumes the remote server to be an edge node which may be configured to provide an application service to a device (with such application services also being referred to as ‘edge application services’ or simply as ‘edge services’), and the offloading to be an offloading of the application service. However, the concepts and mechanisms described in this specification equally apply to any other type of remote server and to any other type of resource service, such as a cloud server providing a cloud service to a client, with other examples of remote servers and resource services being given elsewhere in this specification.

Furthermore, by way of example, the following further assumes the local data communication to be D2D communication [5]. However, the concepts and mechanisms described in this specification equally apply to any other type of local data communication which is independent of a mobile network infrastructure, with examples of such other local data communication being given elsewhere in this specification.

Furthermore, also by way of example, the devices in the following examples are so-called User Equipment (UE) of a mobile network which adheres to one or more 3GPP standards. These devices may in the following also be referred to as ‘mobile devices’ by having connectivity to the mobile network. It is noted that while the UE are described in the following examples to be capable of movement, and in fact shown to move, this is not a limitation, in that the described measures equally apply to devices having connectivity to the mobile network (and thus being ‘mobile devices’) which are stationary or not moving. It is noted that the concepts and mechanisms described in this specification equally apply to any other type of mobile device, which includes mobile devices used with other, e.g., non-3GPP, types of mobile network infrastructures, such as Wi-Fi-based or satellite-based mobile network infrastructures. In general, such mobile devices may also be referred to as ‘mobile clients’ or simply as ‘clients’. Examples of such mobile devices are given elsewhere in this specification.

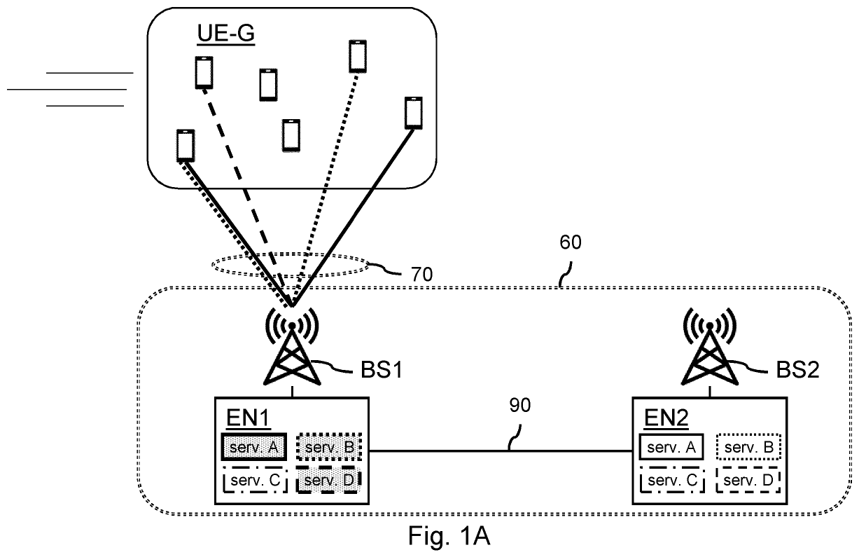

FIG. 1A shows a group of UEs which makes use of application services provided by an edge node. More specifically, FIG. 1A shows a group UE-G which may be comprised of multiple UEs and which may each be in wireless data communication 70 with a base station BS1. The base station BS1 may be part of a mobile network infrastructure 60 together with other base stations, edge nodes and various other (core) components of the mobile network infrastructure which are not shown in FIG. 1A.

Several of the UEs are shown to make use of application services provided by a first edge node EN1, with such use being illustrated in FIG. 1A and elsewhere by different services A-D being shown in the first edge node EN1 as bounding boxes having different outlines: service A with a continuous line, service B with a dotted line, service C with a dashed-dotted line and service D with a dashed line. The services in-use are visualized by the respective bounding box being shaded and by wireless data communication between the base station BS1 and a respective UE being visualized using a same line-type (continuous, dotted, dashed-dotted, dashed) as for the bounding box of the respective service. Accordingly, it can be seen in FIG. 1A that one UE makes use of both services A and B, another UE makes use of service D, yet another UE makes use of service B and another UE makes use of service A.

The first edge node EN1 may have been selected out of several other edge nodes to provide the application service(s) to the respective UEs from the group UE-G since the first edge node EN1 may be most suitable to provide the application service(s), for example by having a high bandwidth and/or low latency connection to the first base station BS1 and thereby to a respective UE connected to the base station BS1, and by having resources available to provide the application service(s).

As is also illustrated in FIG. 1A and in FIGS. 1B-1C, the UE's in the group UE-G may move jointly, for example by being onboard of or part of a moving vehicle, such as a train, or by being onboard of or part of respective vehicles which move jointly, e.g., a vehicle platoon. This is illustrated in FIGS. 1B and 1C, with FIG. 1B showing the group UE-G having moved halfway towards a second base station BS2, and thereby from a serving area of the first base station BS1 (not explicitly shown in FIGS. 1A-1C) into a serving area of the second base station BS2. This may cause UEs being handed-over from the first base station BS1 to the second base station BS2. Accordingly, FIG. 1C shows two of the UEs at the front of the group UE-G having been handed-over from the first base station BS1 to the second base station BS2.

As is known per se, this may also cause edge computing resources to be migrated from the first edge node EN1 to a second edge node EN2 which is most suitable to serve UEs connected to the second base station BS2. Such migration may take various forms, but may in general make use of a backhaul connection 90 between the first edge node EN1 and the second edge node EN2. The migration may be initiated by a message labeled ‘92’. As a result, FIG. 1C shows the two UEs at the front of the group UE-G using respective services from the second edge node EN2. It will be appreciated that further movement into the service area served by the second base station BS2 may also cause the remaining UEs to be migrated in terms of edge resource utilization from the first edge node EN1 to the second edge node EN2.

As also elucidated elsewhere, the repeated handover from base station to base station, the varying quality of the radio link to the base stations, and/or the repeated migration of edge computing resources from edge node to edge node may disrupt or at least hinder the utilization of the application services of the edge nodes. There may also be other reasons that providing an application service from an edge node, or in general a resource service from a remote server, may be disadvantageous. For example, an edge node may have insufficient capacity to serve a large group of UEs. Another example is that the latency from UE to edge node may still be too large.

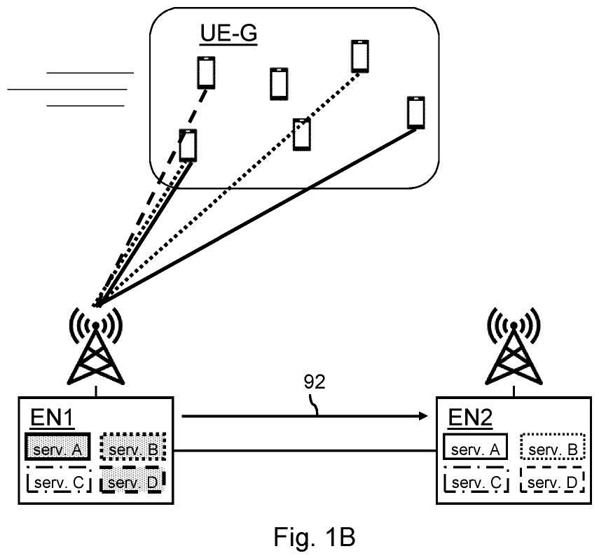

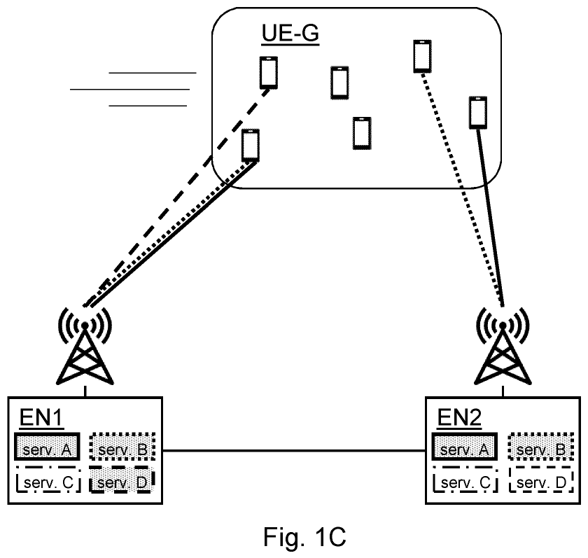

FIGS. 2A-8 describe various examples of how an application service may be offloaded from an edge node to a UE which is in D2D communication range of a UE which is presently utilizing the application service from the edge node. The former UE may also be referred to as a ‘serving UE’ after such offloading or as a ‘candidate serving UE’ before such offloading, while the latter UE may be referred to as ‘client UE’. These examples may have in common that such offloading of an application service may be coordinated by a management system which is separate from the UE(s) and which may for example be part of the mobile network infrastructure, e.g., part of an edge node. The management system may be configured to coordinate the offloading of application service(s) between the different entities involved, namely between the client UE(s) which may presently use the application service from an edge node, the UE that is able to provide the application service via D2D communication, and the edge node.

As elucidated elsewhere, such coordination may involve the exchange of messages with the respective entities and/or decision-making by the management system. With such coordination by the management system, an application service may be transferred in a direct manner from the edge node to the serving UE, with ‘direct manner’ referring to there being no need for the client UE(s) itself having to effect such a transfer, e.g., by having to request another UE to provide the application service via D2D communication. As elucidated elsewhere, such transfer may also be referred to as ‘offloading’ or ‘migration’, and may at least comprise the management system effecting a transfer of data representing state information from the edge node to the serving UE so as to enable the application service to be continued from its previous state from the serving UE. In particular, the management system may selectively steer such offloading based on various considerations, which may generally amount to considerations whether the offloading is possible and whether the offloading is advantageous, e.g., for the client UE(s) and/or for the presently serving edge node.

FIG. 2A shows an information flow between an edge node and three user equipment UE1-UE3 to cause one of the user equipment to provide edge computing application services to the other user equipment as a substitute for the edge node. In this example and in other examples which do not state otherwise, the functionality of the management system may be implemented by the edge node EN. Furthermore, in this example, it is assumed that the edge node EN is configured to provide several application services to UEs, with the respective application services being identified by letters A-D. As such, as also shown in FIG. 2A, UE1 may at a certain moment in time use application services A and B, UE2 may not use any application services and UE3 may use application services B and D from the edge node EN. Furthermore, UE1-UE3 may have regular mobile network connectivity to a mobile network and its infrastructure, which may allow UEs to establish data connections to the edge node EN. Such connections are shown in FIG. 2A by direct lines between the base station and the respective UEs, with the line type (solid, dotted, dashed-dotted, dashed) corresponding to the type of application service being utilized. It is assumed that UE1-UE3 are all capable of setting up D2D connections. As is also shown in FIG. 2B, UE1-UE3 may be authorized for D2D communication, for example using the standard ProSe [5] authentication steps which may involve a ProSe function (not shown in FIG. 2B). The D2D connections are indicated in FIG. 2B by direct lines between the UEs.

In general, an offloading of a select application service(s) from the edge node EN to a UE may involve identifying a candidate serving UE which is in D2D communication range of a client UE and which is capable of providing one or more application services, which is/are currently utilized by the client UE from the edge node EN, to the client UE via D2D communication. It may then be determined whether to proceed with setting up the candidate serving UE to provide the application service(s) to the client UE via D2D communication as a substitute for the edge node EN. If determined to setup the candidate serving UE, the candidate serving UE may then be setup to provide the application service(s) to the client UE via D2D communication. This may comprise transferring state data indicative of a state of the application service(s) from the edge node EN to the to-be-serving UE to enable the client UE to continue the application service(s) from this UE after ceasing to use the application service(s) from the edge node EN. The above steps may be coordinated by a management system on the basis of data received from various entities.

With continued reference to the examples of FIGS. 2A-8, the coordination of the offloading of select application service(s) may involve the following steps:

A. Evaluate performance and/or allocation criteria

B. Identify nearby UE by sending request

C. Acknowledge request by nearby UE

D. Inform management system of nearby UE

E. Instruct UE to check for interest of other UEs

F. Inform management system of result of check for interest

G. Decide whether to offload to UE

H. Offload application service to UE

I. Inform UE(s) of availability of offloaded application service

Here, each step may involve an action of a respective entity, such as a measurement or a decision or a sending of a message. It is noted that internal actions may be represented in FIGS. 2A-8 and elsewhere by an internal circular arrow, whereas sending of messages may be represented by arrows between entities.

In the example of FIGS. 2A-2B, the steps may be specifically as follows, with the numbering of the steps matching the reference numbers in FIGS. 2A-2B:

1. UE1 may measure the performance of any application services which UE1 is utilizing, for example in terms of experienced quality of service or latency.

2. If a particular application service does not meet certain performance requirements, UE1 may send a discovery request via D2D communication; the discovery request may identify the particular application service. For example, in ProSe [5], such a discovery request may be sent in form of an “Are you there?” message.

3. UE2 may be in D2D communication range of UE1 and may receive the discovery request and may in response send a discovery response which may identify application service(s) that may be offered by UE2. For example, in ProSe [5], such a discovery response may be sent in form of an “I am here” message.

4. UE1 may send a message to the edge node EN informing the edge node that it has found a nearby UE (UE2) that can offer certain application service(s).

5. The edge node EN may instruct UE2 to check interest for the application service(s) among other UEs within its D2D communication range.

6. UE2 may check interest amongst other UEs by sending D2D discovery request(s), and may report back to the edge node EN on the result of these request(s).

7. The edge node EN may decide whether it is advantageous to offload the application service(s) to UE2. The qualification of ‘advantageous’ may depend on various factors, such as a current performance of the application service(s) when provided by the edge node EN, an expected future performance of the application service(s) when offloaded to UE, a past or future estimated mobility pattern of UE1 and UE2, and/or whether the interest check by UE2 has indicated that a sufficient number of other UEs are interested in the application service(s) if UE2 were to provide the application service(s) via D2D communication.

8. The selected application service(s), including its/their state(s), may be offloaded from the edge node EN to UE2 using known mechanisms.

9, 9′. The edge node EN may inform all UEs which use the offloaded application service(s) that the application service(s) are now available on UE2. After reception of this message, UEs may start setting up a D2D connection to UE2 and may then start to use the application service provided by UE2 via the D2D connection.

FIG. 2B shows a result of the above, showing UE1 utilizing application services A and B from UE2 via D2D data communication 80, and showing UE3 utilizing application service B from UE2 via D2D data communication and continuing to utilize application service D from the edge node EN via the mobile network infrastructure.

It is noted that steps 2, 3, 6 and 9 may make use of existing ProSe mechanisms [5] by which UEs may be discovered in a D2D context and for setting up D2D connections. Furthermore, in step 8, a known mechanism may be used for migrating application services from one edge node to another edge node while preserving the application service state, such as the mechanism described in [4].

In general, the client UE may be configured to periodically or continuously measure a performance of an application service which is used from an edge node, e.g., as described in the above-mentioned step 1. In general, the client UE may be configured to determine which application service(s) may be offloaded to a nearby UE by sending a request and listening for responses (step 2 and 3). In general, a serving UE may be configured to receive and process the request and to send the discovery response message (step 2 and 3). In general, the client UE may be configured to inform an edge node that it has found a nearby UE that can be used to offload one or more application services (step 4). In general, the client UE may be configured to authorize the D2D connectivity to the UE that offers the application service(s) (step 9). In general, the edge node EN as management system may be configured to instruct a UE to check for interest for an application service (step 5). In general, an edge node configured as management system may be configured to assess whether certain application services can be offloaded to a UE or not, based on the check of interest.

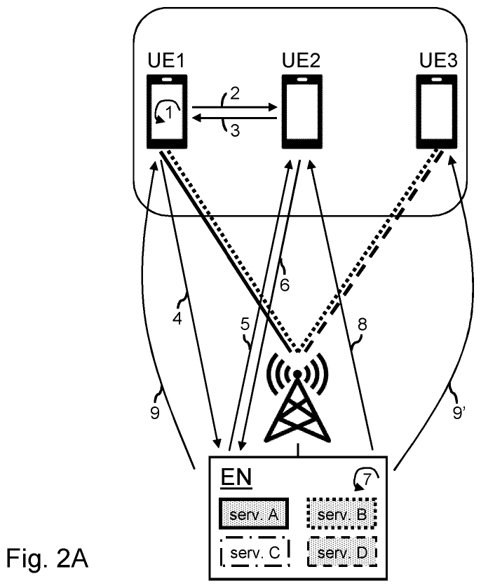

FIG. 3 shows the edge node EN being configured to monitor a quality of service experienced by the UE1 and UE3 when utilizing edge computing application services from the edge node EN, and to trigger an offloading of the edge computing application services to UE2 if the quality of service is insufficient. Compared to FIG. 2A, the monitoring of performance indicators may here be performed by the edge node EN instead of by UE1. For example, the edge node EN may be configured to monitor so-called key performance indicators (KPIs) which may pertain to bandwidth, latency, etc. Such monitoring is indicated in FIG. 3 by an internal step 0. The edge node EN may then trigger the discovery process via a message 1, instead of UE1 itself deciding to trigger the discovery process. The remaining steps match those of FIGS. 2A-2B.

In general, a decision to offload an application service to a UE may be based on resource considerations, such as performance considerations and allocation considerations. Such considerations may be quantified on the basis of the management system evaluating one or more metrics which at least in part characterize a performance and/or an allocation relating to the providing of the application service(s). Such metrics may use measurement data as input. The measurement data may be generated by the management system itself, e.g., by the management system performing the respective measurements. Additionally, or alternatively, the management system may be configured to receive such measurement data from another entity performing the measurement, such as the client UE, a serving UE or the edge node.

For example, a metric may quantify a network characteristic, such as a bandwidth or remaining bandwidth or latency of at least part of the mobile network infrastructure used for the remote data communication. Additionally or alternatively, the metric may quantify a server characteristic, such as a current load or a maximum computing capacity of the edge node, or a device characteristic, such as a current load or maximum computing capacity of the candidate serving UE, or a current quality of service experienced by a UE using the application service(s). In some examples, the metric may quantify a combination of the above performance and allocation aspects.

The decision to offload the application service to the candidate serving UE may be based on absolute or relative values of the metric(s), and/or on an expected change in the metric(s) when the application service(s) is offloaded to a candidate serving UE. Such an expected change may be estimated by the management system.

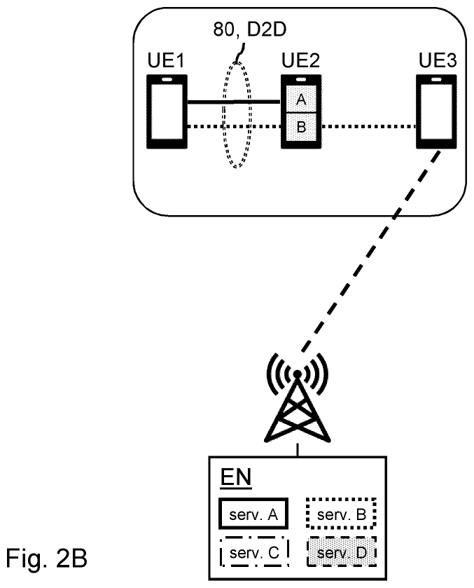

FIG. 4 shows a central server being configured to manage the offloading of edge computing application services to user equipment. In this example, the edge node EN may preconfigure a UE with information on which application services can be offloaded, rather than having the UE propose the application services to be offloaded itself. Furthermore, the edge node EN may, as a part of the decision to offload services to a UE, determine whether mobility patterns of UEs match. This may prevent a client UE being assigned a serving UE which is moving away from the client UE, or vice versa. The mobility pattern may for example be determined at the level of a history of mobile cells or tracking areas. For example, the mobile network may determine and, over time, update a mobility pattern of a UE based on a subscription of the UE, statistics of UE mobility, network local policy and so-called UE assisted information, or any combination of these inputs. The statistics of the UE mobility may for example be based on historical or expected UE movement trajectories. A mobility pattern may be at different geographical scales. An example of a coarser mobility pattern is a history of the tracking areas that a UE has passed through. An example of a finer mobility pattern is a history of mobile cells or sectors, while an example of an even finer mobility pattern is a GPS location history. In general, the mobility pattern may be based on historical and/or current locations and on historical and/or current speed of movement. Such speed of movement may be measured directly or derived from the location information.

With continued reference to FIG. 4, steps identified by reference numerals matching those of FIGS. 2A-2B may correspond to those steps, with step 7 now being performed by a central server CS functioning as management system instead of by the edge node EN. Thereby, the coordination and decision-making may be performed by the central server CS rather than by edge nodes to limit the tasks of edge nodes to tasks which related to the application services themselves.

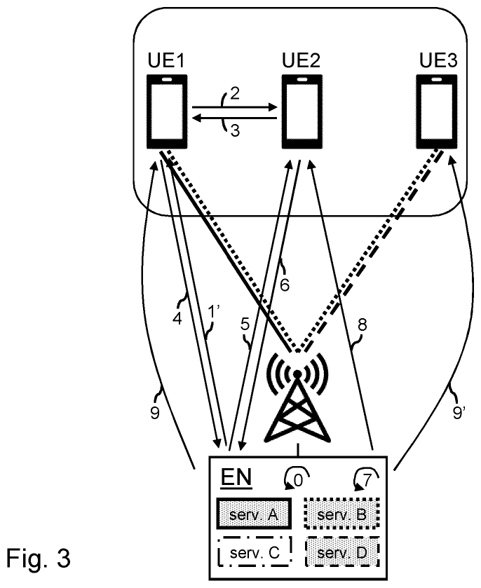

FIG. 5 shows a bottom-up approach in which UE3 is setup to use application service(s) from UE2, with UE2 having been previously setup to serve UE1. Namely, it is assumed that UE2 is already providing services A and B to UE1 via D2D communication, which may have been the result of previously described steps. In addition, UE3 is currently assumed to utilize services B and D from the edge node EN.

11. UE3 may measure the performance of any application services which UE3 is utilizing. This step may otherwise match step 1 as described elsewhere.

12. If a particular application service does not meet certain performance requirements, UE3 may send a discovery request via D2D communication; the discovery request may identify the particular application service. This step may otherwise match step 2 as described elsewhere.

13. UE2 may be in D2D communication range of UE3 and may receive the discovery request and may in response send a message to the edge node EN configured as management system to inform the edge node EN that UE3 is seeking D2D communication-based delivery of application services B and D.

14. The edge node EN may decide whether it is advantageous to offload the application service(s) D to UE2, and whether application service B, which is already provided by UE2 to UE1, should also be provided to UE3.

15. If decided, the selected application service(s), being in this example application service D, including its/their state(s), may be offloaded from the edge node EN to UE2 using known mechanisms. Moreover, if it is decided to provide application service B from UE2 to UE3, state data may be transferred from the edge node EN to UE2 which represents the state of the application service B as utilized by UE3.

16. UE2 may inform UE3 that the application service(s) are now available on UE2, for example by sending a discovery response message to UE3. After reception of this message, UE3 may start setting up a D2D connection to UE2 to be able to utilize the offloaded application service(s).

In general, a UE may receive different types of responses to its discovery request. A first type of response may amount to the candidate serving UE answering that it can support the application service, but with the client UE having to take further steps to effect the offloading, e.g., by informing the edge node EN of the identified candidate serving UE. FIGS. 2-4 may represent this type of response. A second type of response may amount to the candidate serving UE answering that it can support the application service and that it is ready to setup the D2D connection. The candidate serving UE may then take further steps to effect the offloading, e.g., by informing the edge node EN that a client UE is seeking D2D communication-based delivery of an application service. FIG. 5 may represent this type of response, which may be referred to as a ‘bottom-up’ approach by the candidate serving UE rather than the client UE taking the necessary steps to effect the offloading of the application service(s).

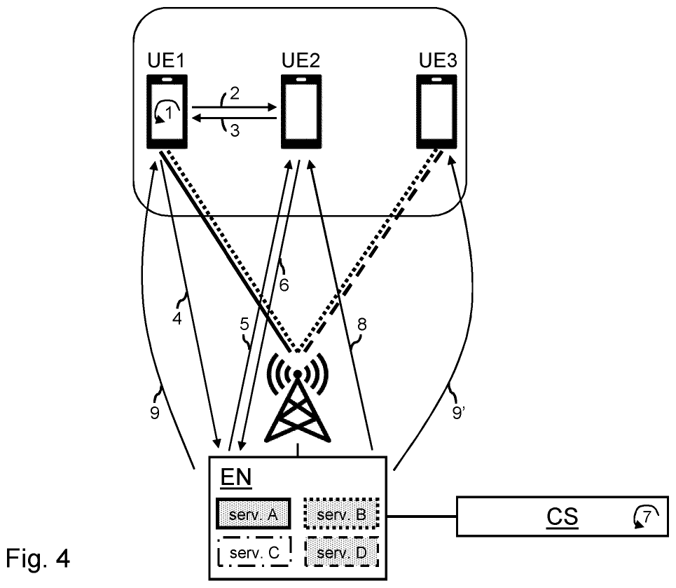

FIG. 6 shows UE2 as candidate serving UE notifying the edge node EN that UE1 as client UE is seeking to obtain application services via D2D communication. Here, the steps may match those of FIGS. 2A-2B, except that the notification to the edge node EN that a nearby UE is available to offer select application service(s) is now sent by the UE that can offer these application service(s), i.e., by the candidate serving UE, instead of by the UE that is seeking to utilize such application service(s) via D2D communication, i.e., by the client UE. This means that step 4 as shown in FIGS. 2A-2B may now be replaced by a step 4′ by which UE2 may announce to the edge node EN that UE1 is seeking to obtain select application service(s) via D2D communication.

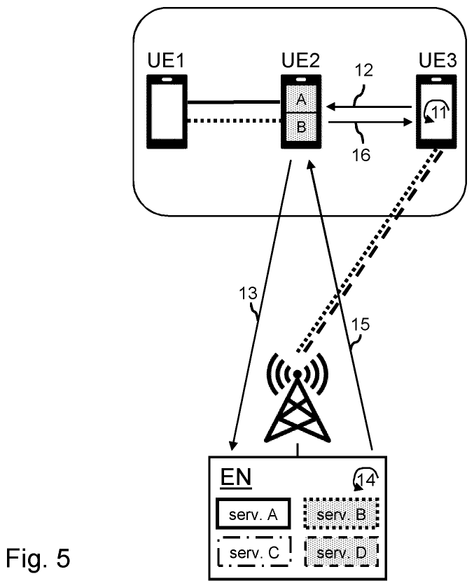

FIG. 7 shows how to coordinate the offloading while using another UE, namely UE4, as a D2D relay node between UE1 and UE2. This example may relate to the following: the discovery and connectivity between UE1 and UE2 (and between other UEs and UE2) may be based on intermediate D2D relay nodes, e.g., on one or more UEs that do not provide application service(s) themselves but rather provide relay connectivity to allow the D2D connection to take place between UE1 and UE2. Here, the steps may match those of FIGS. 2A-2B, but with the communication between UE1 and UE2 now being relayed via UE4. Accordingly, previous steps 2 and 3 which correspond to communication between UE1 and UE2 may now be replaced by steps 2′ and 3′ which correspond to communication between UE1 and UE4 and steps 2″ and 3″ which may correspond to correspond to communication between UE4 and UE2.

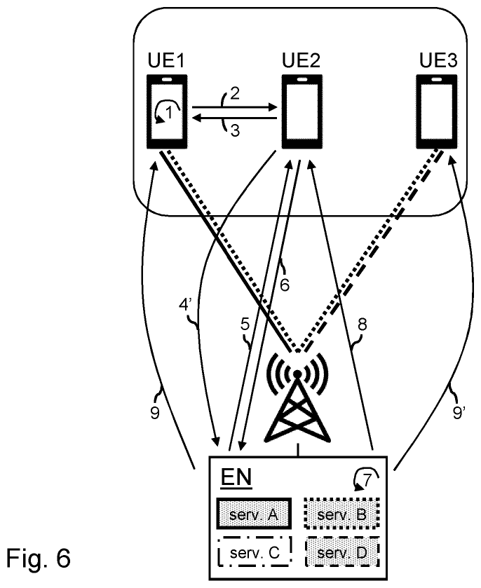

FIG. 8 shows how to coordinate the offloading, where the procedure is repeated to find a better suited UE for offloading. This example may relate to the following: in a situation where UE1 is using application service(s) offered by UE2, more specifically application services A and B, and in which the performance of the D2D connection between UE1 and UE2 degrades and/or the compute performance of UE2 degrades, UE1 may repeat the procedure as previously described with reference to FIGS. 2A-2B to find yet another UE, being in this example UE4, that is able to provide the application service(s) to UE1. Here, the steps may match those of FIGS. 2A-2B, except that steps 2 and 3 are performed between UE1 and UE4 (instead of UE2 as in FIG. 2A), while steps 5 and 6 are performed between the edge node and UE4 (instead of UE2 as in FIG. 2A). Moreover, in step 8, the edge node EN may request UE2 to transfer the state data of the application service(s) utilized by UE1, while in step 8′, UE2 may send the state data to the edge node EN, while in step 8″, the edge node EN may send the state data to UE4. Finally, in steps 9 and 9′, the edge node EN may inform UE1 and UE3 that the application service(s) are now available on UE4.

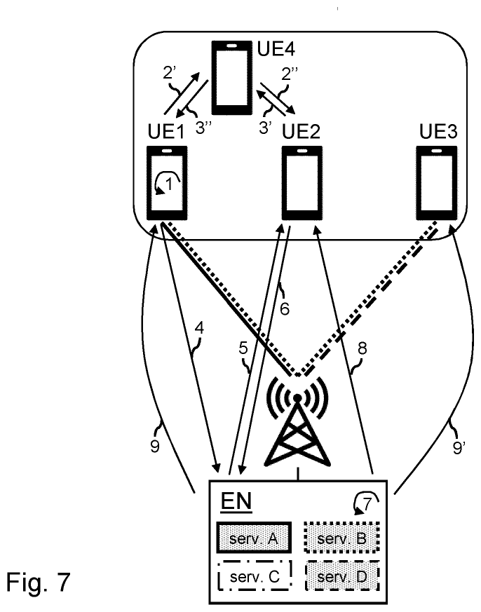

FIG. 9 shows how to coordinate reverting an offloading to UE2. This example may relate to the following: in a situation where UE1 is using application service(s) offered by UE2, and in which the performance of the D2D connection between UE1 and UE2 degrades and/or the compute performance of UE2 degrades, UE1 may request to revert the offloading to UE2 and to resume utilizing the application service(s) from the edge node EN. This may involve the following steps:

21. UE1 may measure the performance of any application services which UE1 is utilizing, for example in terms of experienced quality of service or latency.

22. If some application service(s) cannot deliver the required performance, UE1 may send a request to the edge node EN to revert the offloading.

23. The edge node EN may instruct UE2 to revert the offloading.

24. The selected application service(s), including their states, may be transferred back to the edge node EN using known mechanisms.

25, 25′. The edge node EN may inform all UEs which are using the offloaded application service(s) that the application service(s) are now available from the edge node EN again.

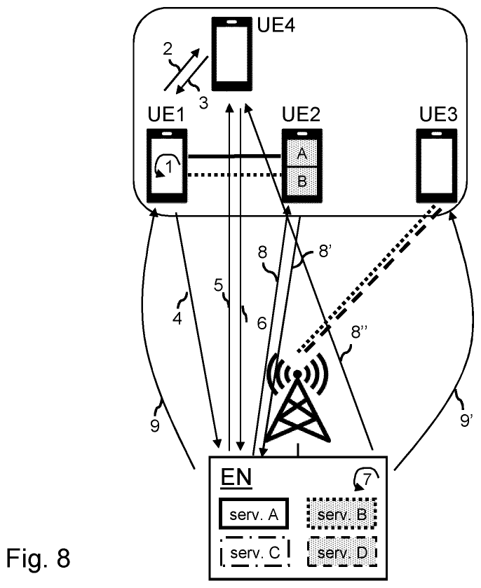

FIG. 10 shows a device 100 which may comprise an infrastructure network interface 110 to a mobile network infrastructure. The infrastructure network interface 110 may for example be a wireless communication interface, which may also be referred to as a radio interface, and which may be configured to connect to a mobile network infrastructure. In some examples, the infrastructure network interface 110 may comprise a radio and an antenna, or a radio and an antenna connection. In a specific example, the infrastructure network interface 110 may be a 4G or 5G radio interface for connecting to a 4G or 5G mobile network adhering to one or more 3GPP standards, or a mobile satellite communication interface for connecting to a satellite network, or a Wi-Fi communication interface for connecting to a Wi-Fi network infrastructure, etc.

The device 100 may further comprise a local network interface 120 for local data communication with other devices independently of the mobile network infrastructure. The local network interface 120 may for example be a wireless communication interface, which may also be referred to as a radio interface. In some embodiments, the local network interface 120 may be the same physical interface as the infrastructure network interface 110 but which may be operated in a different mode so as not to rely on the mobile network infrastructure. For example, both interfaces may be embodied by a 5G radio interface which may be operated in an infrastructure mode and in a D2D communication mode. In some examples, both modes of a same physical interface may be made available in software as different virtual interfaces. In other examples, the local network interface 120 may be a separate interface, which additionally may be of a different type as the infrastructure network interface 110. For example, the local network interface 120 may be a Wi-Fi or Wi-Fi direct communication interface, a Zigbee interface, a Bluetooth interface, a Li-Fi interface, etc.

The device 100 may further comprise a processor subsystem 140 which may be configured, e.g., by hardware design or software, to perform the operations described in this specification in as far as pertaining to a device or UE. For example, the processor subsystem 140 may in some embodiments be configured to perform the operations as described in this specification in relation to a device utilizing a resource service, this being also referred to as a ‘client device’ or ‘client UE’. In other embodiments, the processor subsystem 140 may configured to perform the operations as described in this specification in relation to a device configured to provide a resource service to another device, the former device being also referred to as a ‘serving device’ or ‘serving UE’. In yet other embodiments, the processor subsystem 140 may configured to perform the operations as described in this specification in relation to both types of devices, e.g., to a client device or UE and to serving device or UE. In such embodiments, the device may be configured for both types of operations.

In general, the processor subsystem 140 may be embodied by a single Central Processing Unit (CPU), such as a x86 or ARM-based CPU, but also by a combination or system of such CPUs and/or other types of processing units. As also shown in FIG. 10, the device 100 may comprise a data storage 160, such as a solid-state drive or flash memory, which may be used by the device 100 to store data. For example, the device 100 may store data related to an application service being provided by the device, such as state data and/or a container.

In general, the device 100 may be embodied by a (single) device or apparatus, e.g., a smartphone, personal computer, laptop, tablet device, smart watch, smart glasses, head mounted display device, etc. The device 100 may also be, or be part of, a vehicle such as car, motorcycle, truck, bicycle, scooter, etc. The device 100 may also be part of an autonomous entity, such as an unmanned aerial or non-aerial (e.g. road-based) vehicle or robot. However, the device 100 may also be embodied by a distributed system of such devices or apparatuses. In general, the device 100 may be a so-called User Equipment (UE) or a mobile UE of a mobile telecommunication network, such as a 5G or next-gen mobile network.

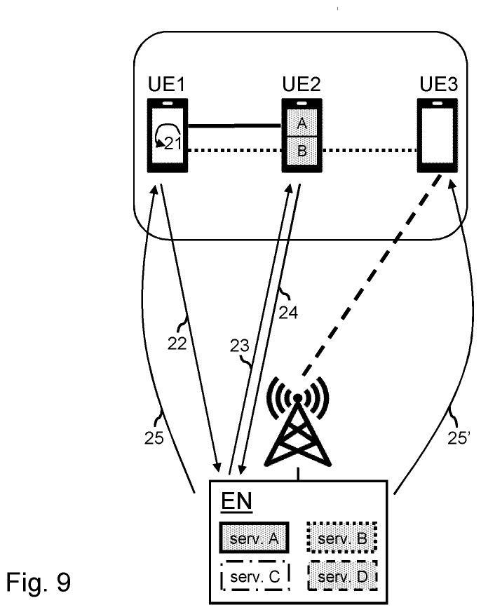

FIG. 11 shows a management system 200 which may comprise a network infrastructure interface 210. The infrastructure network interface 210 may for example be a wired communication interface, such as an Ethernet or fiber-optic based interface, to connect to the mobile network infrastructure from within the mobile network infrastructure. Alternatively, the infrastructure network interface 210 may be a wireless communication interface, e.g., of a type as described for the device 100.

The management system 200 may further comprise a processor subsystem 240 which may be configured, e.g., by hardware design or software, to perform the operations described in this specification in as far as pertaining to a management system, or in general to the management or coordination of an offloading of a resource service from a remote server to a device. In general, the processor subsystem 240 may be embodied by a single Central Processing Unit (CPU), such as a x86 or ARM-based CPU, but also by a combination or system of such CPUs and/or other types of processing units. In embodiments where the management system 200 is distributed over different entities, e.g., over different servers, the processor subsystem 240 may also be distributed, e.g., over the CPUs of such different servers. As also shown in FIG. 11, the management system 200 may comprise a data storage 260, such as a hard drive, an array of hard drives, a solid-state drive, an array of solid-state drives, etc., which may be used by the management system 200 to store data.

In general, the management system 200 may be part of an edge node, e.g., representing a subsystem of the edge node, or may be implemented in a distributed manner using a number of edge nodes. The management system 200 may also be implemented by a non-edge server or a system of such servers. For example, the management system 200 may be implemented by one or more cloud servers.

In general, the device 100 and the management system 200 may each be implemented at least in part by a device or apparatus. The device or apparatus may comprise one or more (micro)processors which execute appropriate software. Software implementing the functionality of function(s) of either entity may have been downloaded and/or stored in a corresponding memory or memories, e.g., in volatile memory such as RAM or in non-volatile memory such as Flash. Alternatively, the function(s) may be implemented in the device or apparatus in the form of programmable logic, e.g., as a Field-Programmable Gate Array (FPGA). In general, each function of either entity may be implemented as or using a circuit.

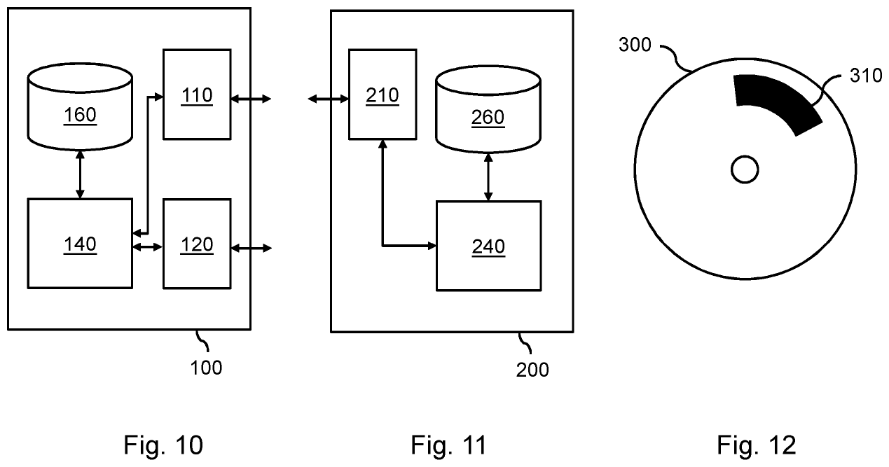

It is noted that any of the methods described in this specification, for example in any of the claims, may be implemented on a computer as a computer-implemented method, as dedicated hardware, or as a combination of both. Instructions for the computer, e.g., executable code, may be stored on a computer readable medium 300 as for example shown in FIG. 12, e.g., in the form of a series 310 of machine-readable physical marks and/or as a series of elements having different electrical, e.g., magnetic, or optical properties or values. The executable code may be stored in a transitory or non-transitory manner. Examples of computer readable mediums include memory devices, optical storage devices, integrated circuits, servers, online software, etc. FIG. 12 shows by way of example an optical storage device 300.

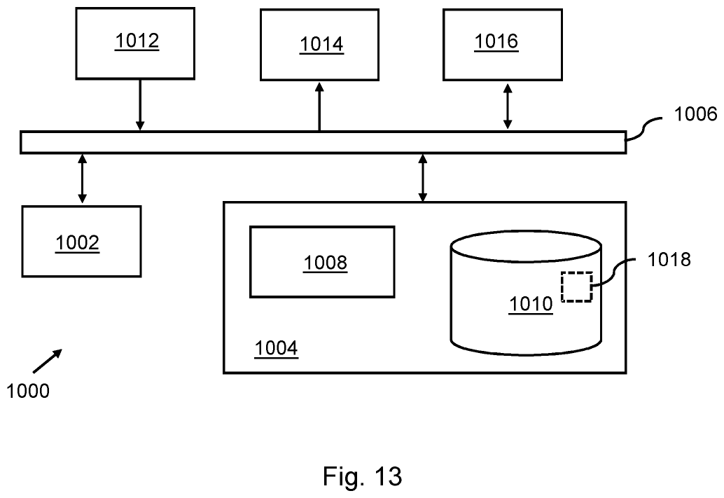

FIG. 13 is a block diagram illustrating an exemplary data processing system that may be used in the embodiments described in this specification. Such data processing systems include data processing entities described in this specification, including but not limited to the management system or device or UE.

The data processing system 1000 may include at least one processor 1002 coupled to memory elements 1004 through a system bus 1006. As such, the data processing system may store program code within memory elements 1004. Further, processor 1002 may execute the program code accessed from memory elements 1004 via system bus 1006. In one aspect, data processing system may be implemented as a computer that is suitable for storing and/or executing program code. It should be appreciated, however, that data processing system 1000 may be implemented in the form of any system including a processor and memory that is capable of performing the functions described within this specification. Memory elements 1004 may include one or more physical memory devices such as, for example, local memory 1008 and one or more bulk storage devices 1010. Local memory may refer to random access memory or other non-persistent memory device(s) generally used during actual execution of the program code. A bulk storage device may be implemented as a hard drive, solid state disk or other persistent data storage device. The processing system 1000 may also include one or more cache memories (not shown) that provide temporary storage of at least some program code in order to reduce the number of times program code must be retrieved from bulk storage device 1010 during execution.

Input/output (I/O) devices depicted as input device 1012 and output device 1014 optionally can be coupled to the data processing system. Examples of input devices may include, but are not limited to, for example, a microphone, a keyboard, a pointing device such as a mouse, a game controller, a Bluetooth controller, a VR controller, and a gesture-based input device, or the like. Examples of output devices may include, but are not limited to, for example, a monitor or display, speakers, or the like. Input device and/or output device may be coupled to data processing system either directly or through intervening I/O controllers. A network adapter 1016 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Modems, cable modems, and Ethernet cards are examples of different types of network adapter that may be used with data processing system 1000.

As shown in FIG. 13, memory elements 1004 may store an application 1018. It should be appreciated that data processing system 1000 may further execute an operating system (not shown) that can facilitate execution of the application. The application, being implemented in the form of executable program code, can be executed by data processing system 1000, e.g., by processor 1002. Responsive to executing the application, the data processing system may be configured to perform one or more operations to be described herein in further detail.

In one aspect, for example, data processing system 1000 may implement the management system. In that case, application 1018 may represent an application that, when executed, configures data processing system 1000 to perform the functions described in this specification with reference to the management system. In another aspect, data processing system 1000 may implement a device or UE as described in this specification. In that case, application 1018 may represent an application that, when executed, configures data processing system 1000 to perform the functions described in this specification with reference to the device or UE.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or stages other than those stated in a claim. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method of managing remote resource utilization by a first device, wherein the first device is configured to use a resource service provided by a remote server, wherein the resource service enables the first device to utilize a resource of the remote server, wherein the first device is connected to the remote server via a mobile network infrastructure and configured to use the resource service via remote data communication with the remote server, wherein the first device is capable of local data communication with other devices independently of the mobile network infrastructure,
the method comprising, by a management system:
identifying a second device which is in local data communication range of the first device and which is capable of providing the resource service to the first device via local data communication;
determining whether to setup the second device to provide the resource service to the first device via local data communication as a substitute for the remote server;
if determined to setup the second device, setting up the second device to provide the resource service to the first device via local data communication, said setting up comprising transferring state data indicative of a state of the resource service from the remote server to the second device to enable the first device to continue the resource service from the second device after ceasing to use the resource service from the remote server.

2. The method according to claim 1, further comprising:
evaluating a metric which at least in part characterizes the providing of thy: resource service by the remote server or by the second device;
wherein the determining whether to setup the second device to provide the resource service is based on the metric.

3. The method according to claim 2, wherein the metric is indicative of at least one of:
a network performance characteristic of at least part of the mobile network infrastructure used for the remote data communication;
a server performance characteristic of the remote server;
a device performance characteristic of the second device
a network allocation of at least part of the mobile network infrastructure used for the remote data communication;
a server resource allocation of the remote server; and
a device resource allocation of the second device; and
a quality of service which is experienced by the first device when using the resource service via the mobile network infrastructure.

4. The method according to claim 2, wherein the determining whether to setup the second device to provide the resource service is based on an estimated change in the metric when using the second device to provide the resource service as the substitute for the remote server.

5. The method according to claim 1, wherein the determining whether to setup the second device to provide the resource service is further based on a presence of a number of other devices which use the resource service from the remote server and which are reconfigurable to use the resource service from the second device via local data communication.

6. The method according to claim 5, further comprising requesting the second device to determine and identify the number of other devices by sending a discovery request using local data communication.

7. The method according to claim 1, further comprising, after setting up the second device to provide the resource service, informing the first device that the second device is available for providing the resource service via local data communication as the substitute for the remote server.

8. The method according to claim 1, wherein the determining whether to setup the second device to provide the resource service is further based on a mobility pattern of the first device and/or the second device.

9. The method according to claim 1, wherein the local data communication comprises device-to-device (D2D) communication, for example using Proximity Services, ProSe.

10. The method according to claim 1, to wherein the remote server is an edge node or a system of edge nodes of the mobile network infrastructure, and wherein the resource service is an edge application service.

11. A computer-readable medium comprising transitory or non-transitory data representing a computer program, the computer program comprising instructions for causing a processor system to perform the method according to claim 1.

12. A management system for managing remote resource utilisation by a first device, wherein the first device is configured to use a resource service provided by a remote server, wherein the resource service enables the first device to utilize a resource of the remote server, wherein the first device is connected to the remote server via a mobile network infrastructure and configured to use the resource service via remote data communication with the remote server, wherein the first device is capable of local data communication with other devices independently of the mobile network infrastructure,
the management system comprising:
a network interface to the mobile network infrastructure;
a processor subsystem configured to:
identifying a second device which is in local data communication range of the first device and which is capable of providing the resource service to the first device via local data communication;
determining whether to setup the second device to provide the resource service to the first device via local data communication as a substitute for the remote server;
if determined to setup the second device, setting up the second device to provide the resource service to the first device via local data communication, said setting up comprising transferring state data indicative of a state of the resource service from the remote server to the second device to enable the first device to continue the resource service from the second device after ceasing to use the resource service from the remote server.

13. A device configured to use a resource service provided by a remote server, wherein the resource service enables the device to utilize a resource of the remote server, wherein the device comprises:
an infrastructure network interface to a mobile network infrastructure, wherein the remote server is reachable via the mobile network infrastructure;
a local network interface for local data communication with other devices independently of the mobile network infrastructure;
a processor subsystem configured to:
using the infrastructure network interface, use the resource service of the remote server via remote data communication with the remote server;
using the local network interface, identify a further device which is in local data communication range of the device and which is capable of providing the resource service to the device via local data communication;
using the infrastructure network interface, provide identification data identifying the further device to a management server which is configured to manage remote resource utilization by the device; and
on receiving a message which indicates that the resource service is available from the further device, switching from using the resource service of the remote server via the mobile network infrastructure to using the resource service from the further device via local data communication.

14. The device according to claim 13, wherein the processor subsystem is further configured to:
using the local network interface, identifying a number of other devices which use the resource service from the remote server and which are reconfigurable to use the resource service from the second device via local data communication;
using the infrastructure network interface, providing identification data identifying the number of other devices to the management system.

15. A device which is configurable to provide a resource service to a further device, wherein the resource service enables the further device to utilize a resource of the device, wherein the device comprises:
an infrastructure network interface to a mobile network infrastructure;
a local network interface for local data communication with other devices independently of the mobile network infrastructure;
a processor subsystem configured to:
using the infrastructure network interface, receiving state data indicative of a state of the resource service:
using the local network interface, provide the resource service via local data communication to the further device, wherein the resource service is setup by the processor subsystem to continue at the state indicated by the state data.
